(19) United States
(12) Patent Application Publication
(10) Pub. No.: US 2022/0203527 A1
(43) Pub. Date: Jun. 30, 2022

(54) CONTROL DEVICE, TASK SYSTEM, CONTROL METHOD AND CONTROL PROGRAM

(71) Applicant: TOYOTA JIDOSHA KABUSHIKI KAISHA, Toyota-shi (JP)

(72) Inventors: Hirotaka KOMURA, Setagaya-ku (JP); Kunihiro IWAMOTO, Nagakute-shi (JP); Yuta ITOZAWA, Nagoya-shi (JP); Yutaro TAKAGI, Edogawa-ku (JP); Yoshiaki NAKAMOTO, Nisshin-shi (JP); Junya OTA, Edogawa-ku (JP)

(73) Assignee: TOYOTA JIDOSHA KABUSHIKI KAISHA, Toyota-shi (JP)

(21) Appl. No.: 17/524,271

(22) Filed: Nov. 11, 2021

(30) Foreign Application Priority Data
Dec. 25, 2020 (JP) 2020-216574

(51) Int. Cl. B25J 9/16; B25J 9/00; B25J 13/00

(52) U.S. Cl. CPC B25J 9/1651; B25J 13/003; B25J 9/0003

(57) ABSTRACT

A control device according to an aspect of the present disclosure is a control device for a robot that operates in a facility used by a user, and includes a detection information acquisition unit that acquires detection information of the user who is present in a preset area of the facility, and a control unit that controls the robot such that the robot operates at a speed equal to or lower than a set maximum operation speed based on the detection information of the user.

### CROSS-REFERENCE TO RELATED APPLICATION

This application claims priority to Japanese Patent Application No. 2020-216574 filed on Dec. 25, 2020, incorporated herein by reference in its entirety.

### BACKGROUND

### 1. Technical Field

The present disclosure relates to a control device, a task system, a control method and a control program, and for example, a control device, a task system, a control method and a control program for controlling a robot operating in a facility used by a user.

### 2. Description of Related Art

In recent years, robots may operate to execute tasks such as transportation of packages in facilities such as houses. For example, WO 2020/071235 discloses a technique for operating a robot such that the noise in a target area becomes equal to or lower than a noise level that is preset through an interface.

### SUMMARY

The applicant has found the following issue. The technique in WO 2020/071235 can achieve reduction of noise in the target area. However, there is an issue that, even when no person is present in the target area, movement of the robot is restricted and an operation efficiency of a task by the robot is therefore lowered.

The present disclosure has been made in view of the issue above, and realizes a control device, a task system, a control method, and a control program capable of achieving both operation efficiency of tasks by a robot and noise reduction.

A control device according to an aspect of the present disclosure is a control device for a robot that operates in a facility used by a user, and includes: a detection information acquisition unit that acquires detection information of the user who is present in a preset area of the facility; and a control unit that controls the robot such that the robot operates at a speed equal to or lower than a set maximum operation speed based on the detection information of the user.

The above-mentioned control device includes a maximum speed acquisition unit that acquires the maximum operation speed set by the user. The maximum operation speed may be an operation speed of the robot at which a volume of an operation sound of a drive mechanism of the robot when the robot operates becomes equal to or lower than a noise level determined by the user.

In the above-mentioned control device, when the user is present in the area, the control unit may control the robot such that the robot operates at the speed equal to or lower than the set maximum operation speed.

In the above-mentioned control device, when the user is present within a range set for the robot, the control unit may control the robot such that the robot operates at the speed equal to or lower than the set maximum operation speed.

In the above-mentioned control device, the preset area of the facility may be a room of a house used by the user.

A task system according to an aspect of the present disclosure includes: the above-mentioned control device; a robot controlled by the control device to execute a task; and a detection unit that detects a user who is present in a preset area of a facility.

The above-mentioned task system may include a maximum speed setting unit used by the user to set a maximum operation speed of the robot.

The control method according to an aspect of the present disclosure is a control method that controls a robot that operates in a facility used by a user, and includes: a step of acquiring detection information of the user who is present in a preset area of the facility; and a step of controlling the robot such that the robot operates at a speed equal to or lower than a set maximum operation speed based on the detection information of the user.

The above-mentioned control method may further include a step of acquiring the maximum operation speed set by the user. The maximum operation speed may be an operation speed of the robot at which a volume of an operation sound of a noise source of the robot when the robot operates becomes equal to or lower than a noise level determined by the user.

A control program according to an aspect of the present disclosure is a control program that controls a robot that operates in a facility used by a user and that causes a computer to execute: a process of acquiring detection information of the user who is present in a preset area of the facility; and a process of controlling the robot such that the robot operates at a speed equal to or lower than a set maximum operation speed based on the detection information of the user.

According to the present disclosure, it is possible to realize a control device, a task system, a control method, and a control program capable of achieving both operation efficiency of tasks by the robot and noise reduction.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically showing a configuration of a task system according to a first embodiment;

FIG. 2 is a perspective view schematically showing a robot according to the first embodiment;

FIG. 3 is a side view schematically showing the robot according to the first embodiment;

FIG. 4 is a block diagram showing a system configuration of the robot according to the first embodiment;

FIG. 5 is a view of an accommodating portion as viewed from the inside of a room of a house;

FIG. 6 is a perspective view showing a package transported using the robot;

FIG. 7 is a block diagram showing functional elements of a control device according to the first embodiment;

FIG. 8 is a flowchart showing a flow of executing a task using the task system according to the first embodiment; and

FIG. 9 is a diagram showing an example of a hardware configuration included in the control device and the task system.

### DETAILED DESCRIPTION OF EMBODIMENTS

Hereinafter, specific embodiments to which the present disclosure is applied will be described in detail with reference to the drawings. However, the present disclosure is not limited to the following embodiments. Further, in order to clarify the explanation, the following description and drawings are simplified as appropriate.

### First Embodiment

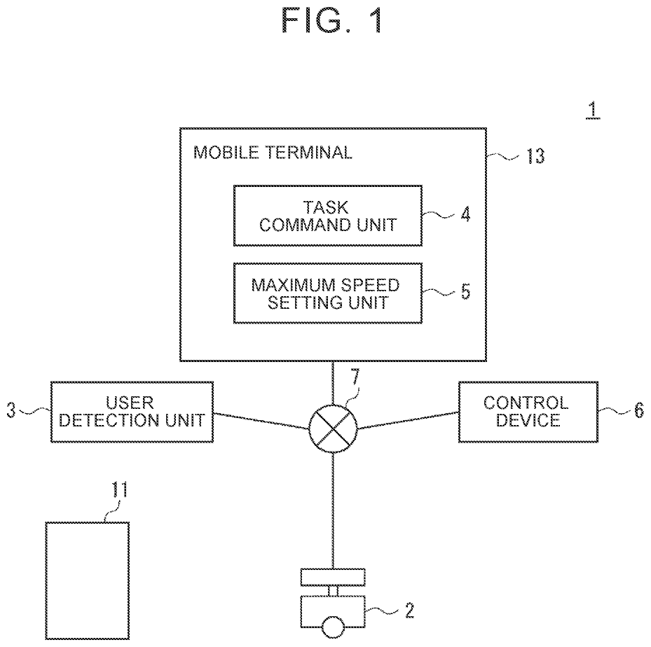

FIG. 1 is a diagram schematically showing a configuration of a task system according to the present embodiment. The task system 1 can be used, for example, when a robot 2 is used to execute a task in a preset area of a facility used by a user such as a house. Therefore, the number of users is one or more. Here, in the following description, the case of a room of the house as the preset area of the facility will be described as a representative.

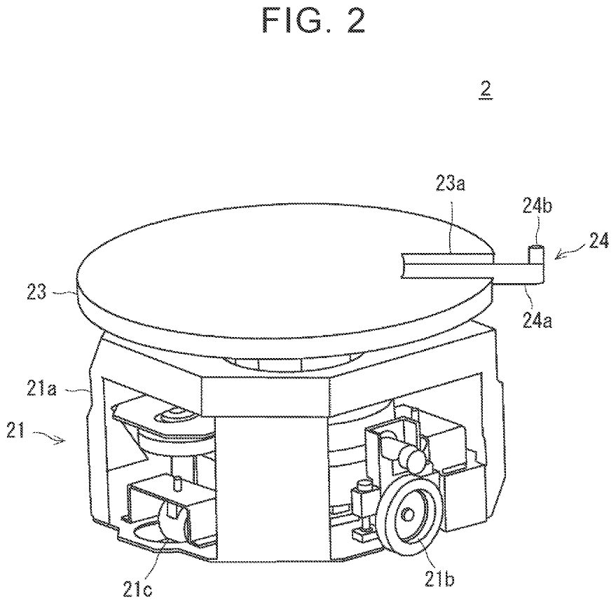

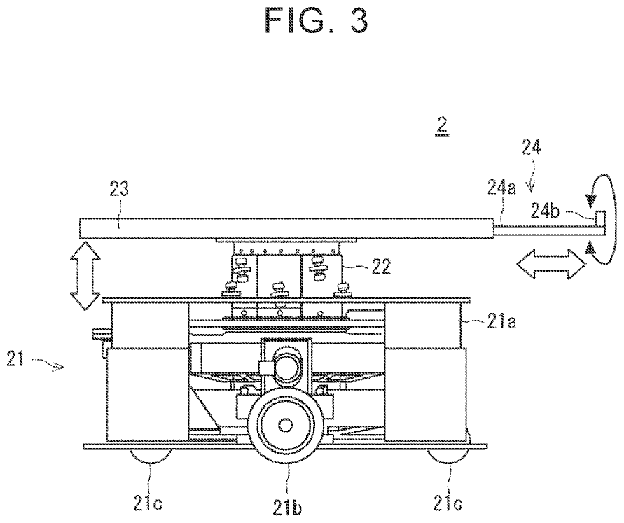

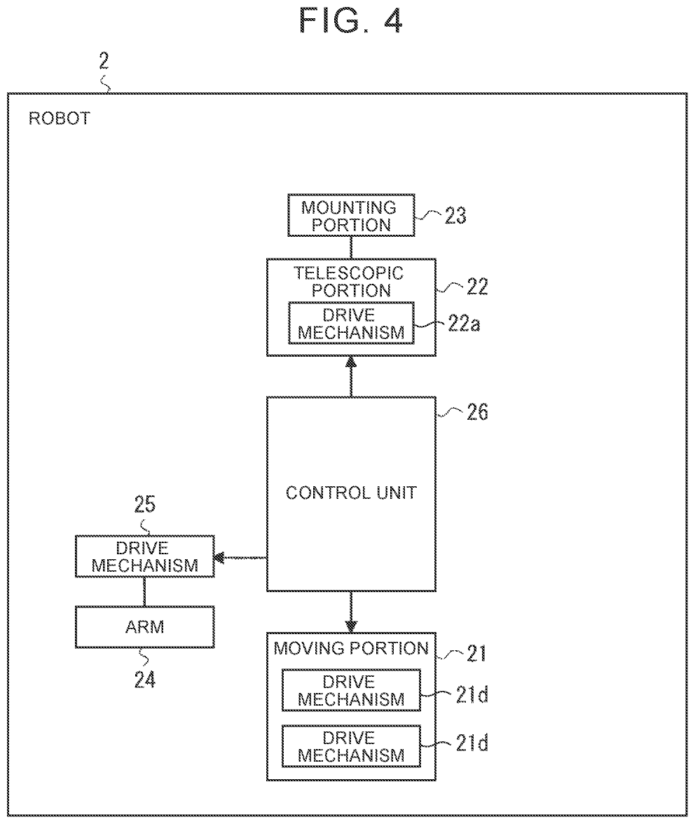

For example, as shown in FIG. 1, the task system 1 includes the robot 2, a user detection unit 3, a task command unit 4, a maximum speed setting unit 5, and a control device 6. FIG. 2 is a perspective view schematically showing the robot according to the present embodiment. FIG. 3 is a side view schematically showing the robot according to the present embodiment. FIG. 4 is a block diagram showing a system configuration of the robot according to the present embodiment.

The robot 2 is, for example, an autonomous mobile robot. As shown in FIG. 1, the robot 2 can realize tasks such as loading and unloading a package and transporting the package to and from an accommodating portion 11 disposed in a room of a house.

Specifically, as shown in FIGS. 1 to 4, the robot 2 includes a moving portion 21, a telescopic portion 22, a mounting portion 23, an arm 24, a drive mechanism 25, and a control unit 26, and is connected to a network 7. Here, the network 7 is, for example, the Internet, and is constructed by a telephone line network, a wireless communication path, Ethernet (registered trademark), or the like.

The moving portion 21 includes a robot body 21a, a pair of right and left drive wheels 21b that is rotatably provided for the robot body 21a, a pair of front and rear driven wheels 21c, and drive mechanisms 21d that rotatably drive the respective drive wheels 21b.

The drive mechanisms 21d each include a motor, a speed reducer, and the like. Each of the drive mechanisms 21d is driven based on control information received from the control unit 26 and rotates the corresponding drive wheel 21b such that the robot body 21a can move forward and rearward, and rotate.

With this configuration, the robot body 21a can move to an arbitrary position. The configuration of the moving portion 21 is an example, and the present disclosure is not limited to this. For example, the number of the drive wheels 21b and the driven wheels 21c of the moving portion 21 may be arbitrary, and a known mechanism can be used as long as the robot 2 can be moved to an arbitrary position.

The telescopic portion 22 is a telescopic mechanism that expands and contracts in an up-down direction. The telescopic portion 22 may be configured as a telescopic type expansion and contraction mechanism. The telescopic portion 22 includes a drive mechanism 22a including a motor, a speed reducer, and the like, and is driven based on the control information received from the control unit 26.

The mounting portion 23 is provided in an upper portion (at a tip) of the telescopic portion 22. The mounting portion 23 moves up and down due to expansion and contraction of the telescopic portion 22. In the present embodiment, the mounting portion 23 is used for loading the package transported by the robot 2.

Then, in order to transport the package, the robot 2 moves together with the package while package is supported by the mounting portion 23. With this configuration, the robot 2 transports the package. However, in the robot 2, when the mounting portion 23 can be lifted and lowered, a known mechanism can be used instead of the telescopic portion 22.

The mounting portion 23 includes, for example, a plate material serving as an upper surface and a plate material serving as a lower surface. A space for accommodating the arm 24 and the drive mechanism 25 is provided between the upper surface and the lower surface. In the present embodiment, the shape of the mounting portion 23 is, for example, a flat disk shape, but any other shape may be used.

More specifically, in the present embodiment, the mounting portion 23 is provided with a cutout 23a along a line of flow of the arm 24 such that, when the arm 24 is moved, a protruding portion 24b of the arm 24 does not interfere with the mounting portion 23. The cutout 23a is provided at least on the upper surface of the mounting portion 23.

The mounting portion 23 is provided with the arm 24 that is horizontally moved in and out of the mounting portion 23. The arm 24 includes a shaft portion 24a extending in the horizontal direction and the protruding portion 24b that extends in the direction perpendicular to the shaft portion 24a and is provided at the tip of the shaft portion 24a. That is, in the present embodiment, the arm 24 is L-shaped.

The drive mechanism 25 moves the arm 24 in the horizontal direction (that is, the direction along the shaft portion 24a, in other words, the longitudinal direction of the arm 24) and rotates around the shaft portion 24a, based on the control information received from the control unit 26.

The drive mechanism 25 includes, for example, a motor and a linear guide, and moves the arm 24 in the horizontal direction and rotates the arm 24. As the drive mechanism 25, a known mechanism for performing the operations above can be used. The drive mechanism 25 is provided in the mounting portion 23.

As described above, the arm 24 is movable in the horizontal direction, and the protruding portion 24b is rotatable as the arm 24 rotates around the shaft portion 24a. That is, the protruding portion 24b can rotate with the shaft portion 24a as a rotation axis.

The control unit 26 controls the operation of the robot 2. That is, the control unit 26 controls the operations of the moving portion 21, the telescopic portion 22, and the arm 24. The control unit 26 can control the rotation of each drive wheel 21b and move the robot 2 to an arbitrary position by transmitting the control information to the drive mechanism 21d of the moving portion 21.

Further, the control unit 26 can control the height of the mounting portion 23 by transmitting the control information to the drive mechanism 22a of the telescopic portion 22. Further, the control unit 26 can control the horizontal movement of the arm 24 and the rotation around the shaft portion 24a by transmitting the control information to the drive mechanism 25.

As described above, the control unit 26 may control movement of the robot 2 by executing known control such as feedback control and robust control based on rotation information of the drive wheels 21b detected by rotation sensors provided for the drive wheels 21b.

Further, the control unit 26 may cause the robot 2 to move autonomously by controlling the moving portion 21 based on information such as distance information detected by a distance sensor such as a camera or an ultrasonic sensor provided for the robot 2 and map information on moving environment.

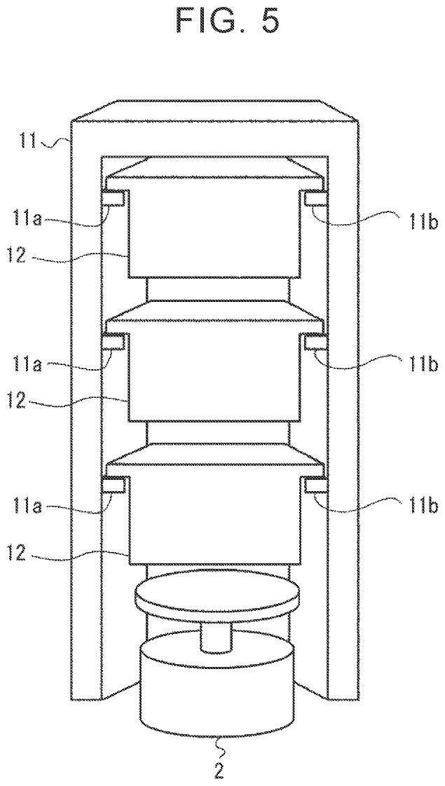

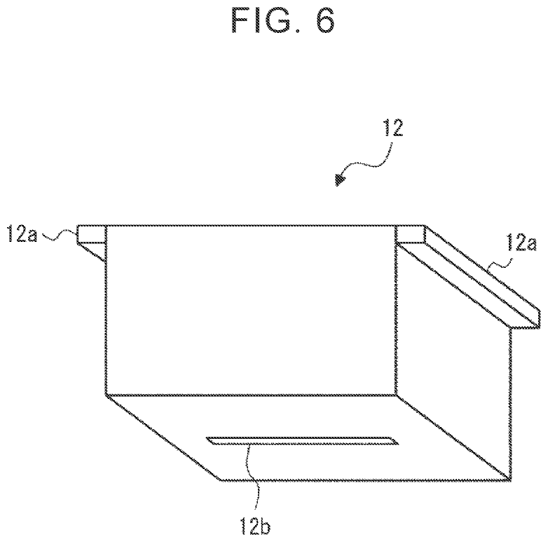

The accommodating portion 11 stores the packages to be transported by the robot 2. FIG. 5 shows an example of the accommodating portion, and is a view of the accommodating portion viewed from the inside of the room of the house. FIG. 6 is a perspective view showing the package transported using the robot. Note that FIG. 5 also shows the robot 2 disposed in front of the accommodating portion 11.

The accommodating portion 11 is disposed in the room in which the robot 2 is disposed in the house as described above, and is configured such that the robot 2 can put in and take out the package. As shown in FIG. 5, the accommodating portion 11 includes a rectangular frame as a basic form, for example, and includes an open portion at least in front of the accommodating portion 11.

In the internal space of the accommodating portion 11, a plurality of pairs of rails 11a, 11b disposed so as to face each other is provided at intervals in the up-down direction. The rails 11a, 11b extend in a front-rear direction of the accommodating portion 11. However, the accommodating portion 11 only need to have a configuration in which the robot 2 can put in and take out the package.

As shown in FIG. 6, a package 12 is a container having a box shape as a basic form. Then, for example, flanges 12a are provided on respective sides of the package 12. The package 12 is supported in the accommodating portion 11 as the flanges 12a are supported by the rails 11a, 11b of the accommodating portion 11 from below.

With this configuration, the package 12 can move inside the accommodating portion 11 in the front-rear direction of the accommodating portion 11 along the rails 11a, 11b of the accommodating portion 11. Therefore, the package 12 can be pulled out from the accommodating portion 11 and the package 12 can be pushed into the accommodating portion 11. However, the package 12 only needs to have a configuration that can be supported by the rails 11a, 11b of the accommodating portion 11.

As shown in FIG. 6, a groove 12b for hooking the protruding portion 24b of the arm 24 is provided on the bottom surface of the package 12 at a predetermined position. Note that, the package 12 is, for example, a container having a box shape as a basic form. However, the package 12 is not limited to this and may be any object. Any other object can be accommodated in the package 12 as a container.

The user detection unit 3 is disposed in the room in which the robot 2 is disposed in the house, and detects a user who is present in the room. The user detection unit 3 can be configured by a motion sensor such as an infrared camera. The user detection unit 3 is connected to the network 7.

However, the user detection unit 3 can use a known sensor capable of detecting a person. Further, the user detection unit 3 may be configured by a camera that the robot 2 includes to acquire the surrounding environment of the robot 2.

For example, the task command unit 4 is operated by the user in order to designate the package 12 for which the task is executed and to input (command) the content (type) of the task to be executed by the robot 2. As shown in FIG. 1, for example, the task command unit 4 is preferably mounted on the mobile terminal 13. The user can issue a command by selecting the identification information of the package 12 and the content of the task to be executed for the package 12 displayed on a display unit of the mobile terminal 13. The task command unit 4 is connected to the network 7. The task command unit 4 only needs to be capable of inputting information necessary for executing the task.

The maximum speed setting unit 5 is operated by the user to set the maximum operation speed of the robot 2. As shown in FIG. 1, for example, the maximum speed setting unit 5 is preferably mounted on the mobile terminal 13. The user can set the maximum operation speed of the robot 2 via the mobile terminal 13. The maximum speed setting unit 5 is connected to the network 7.

Here, the maximum operation speed of the robot 2 may be any speed at which the robot 2 operates at a speed equal to or lower than the noise level that the user does not feel uncomfortable with an operation sound of the robot 2 when the robot 2 operates while the user is present in the room of the house, and is slower than the normal operation speed of the robot 2. Here, the “normal operation” is an operation in a state where the operation speed is not limited.

The maximum operation speed of the robot 2 described above can be set to an operation speed of the robot 2 at which the user does not feel uncomfortable with the operation sound of the robot 2 by actually operating the robot 2. At this time, it is preferable that the maximum operation speeds of the drive mechanisms 21d, 22a, and 25 of the robot 2 can be selectively set.

Note that, the maximum operation speed of the robot 2 may be set through the supervised learning of a model in which the volume of the operation sound of the robot 2 is an input and the maximum operation speed of the robot 2 is an output, with an evaluation with which a plurality of persons does not feel uncomfortable as a correct answer.

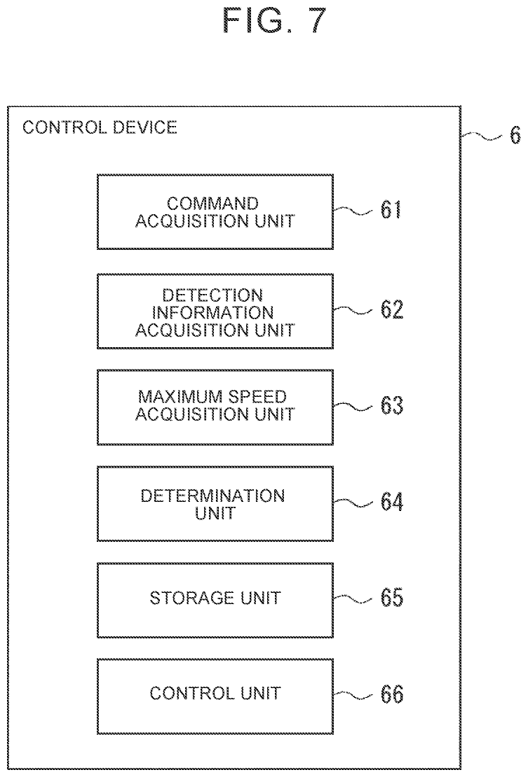

The control device 6 controls the robot 2. Here, FIG. 7 is a block diagram showing functional elements of the control device according to the present embodiment. As shown in FIG. 7, the control device 6 includes a command acquisition unit 61, a detection information acquisition unit 62, a maximum speed acquisition unit 63, a determination unit 64, a storage unit 65, and a control unit 66, and is connected to the network 7.

The command acquisition unit 61 acquires, for example, designation of the package 12 for which a task is executed and the content of the task to be executed by the robot 2. The designation and the content are indicated by the information received from the task command unit 4. Note that, the command acquisition unit 61 may include the task command unit 4. In short, the command acquisition unit 61 only needs to acquire the designation of the package 12 and the content of the task.

Here, the content of the task to be executed by the robot 2 according to the present embodiment is a task to pull out and transport the package 12 supported by the desired rails 11a, 11b of the accommodating portion 11, or a task to push the transported package 12 into the desired rails 11a, 11b of the accommodating portion 11 to accommodate the package 12 in the accommodating portion 11.

The detection information acquisition unit 62 acquires, for example, the detection result of the user who is present in the room of the house. The detection result is indicated by the information received from the user detection unit 3. However, the detection information acquisition unit 62 may include the user detection unit 3. In short, the detection information acquisition unit 62 only needs to acquire the detection result of the user who is present in the room of the house.

The maximum speed acquisition unit 63 acquires the maximum operation speed of the robot 2 indicated by the information received from the maximum speed setting unit 5. The maximum speed acquisition unit 63 may include the maximum speed setting unit 5. In short, the maximum speed acquisition unit 63 only needs to acquire the maximum operation speed of the robot 2.

The determination unit 64 determines whether the user is present in the room of the house. The storage unit 65 stores the type information of the task to be executed by the robot 2, the identification information of the package 12 accommodated in the accommodating portion 11, the position information of the accommodating portion 11 in the room of the house, the position information of the rails 11a, 11b in the accommodating portion 11, and the information on the maximum operation speed of the robot 2. Here, the identification information of the package 12 and the position information of the rails 11a, 11b in the accommodating portion 11 are preferably associated with each other.

Although the details will be described later, the control unit 66 controls the robot 2 such that the robot 2 operates at a speed equal to or lower than the maximum operation speed based on the determination result of the determination unit 64. Further, the control unit 66 controls the user detection unit 3 based on the task command indicated by the information received from the task command unit 4.

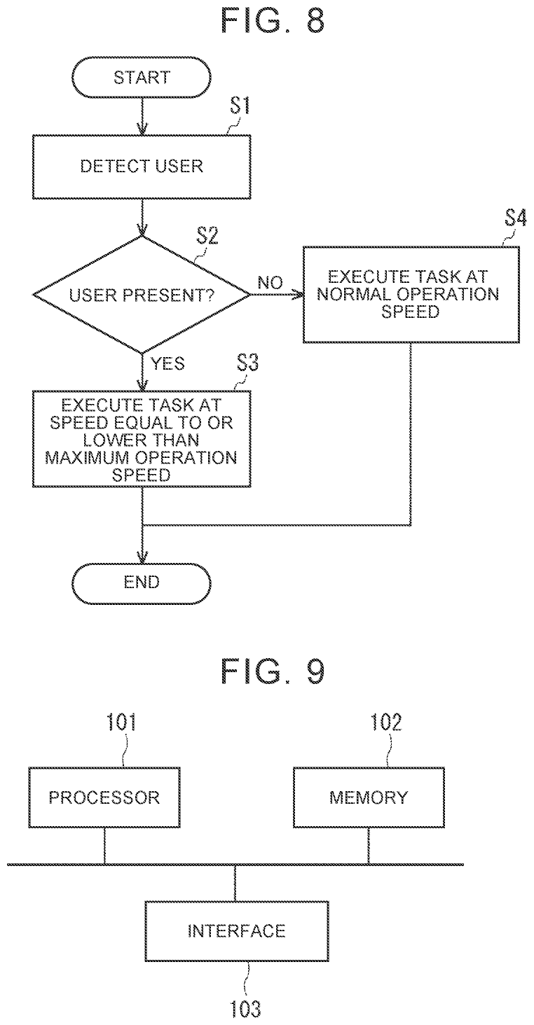

Next, the processing flow of the task system 1 according to the present embodiment will be described. FIG. 8 is a flowchart showing a flow of executing a task using the task system according to the present embodiment. Here, in the following description, it is assumed that the robot 2 executes a task to take out the package 12 accommodated in the accommodating portion 11 and transport the package 12.

Further, it is assumed that the user presets the maximum operation speed of the robot 2 via the maximum speed setting unit 5 mounted on the mobile terminal 13, and information indicating the maximum operation speed of the robot 2 is stored in the storage unit 65.

First, when the user inputs designation of the package 12 and the content of the task to be executed by the robot 2 via the task command unit 4 mounted on the mobile terminal 13, the task command unit 4 transmits, to the control device 6, information indicating the designation of the package 12 and the content of the task to be executed by the robot 2. With this process, the task system 1 starts the task.

Then, the control unit 66 of the control device 6 controls the user detection unit 3 so as to detect the user who is present in the room of the house. The user detection unit 3 executes detection of the user who is present in the room of the house, and transmits the detection information to the control device 6. With this process, the detection information acquisition unit 62 of the control device 6 acquires the detection result of the user who is present in the room of the house (S1).

Next, the determination unit 64 of the control device 6 determines whether the user is present in the room of the house based on the received detection result of the user (S2). Then, when the determination unit 64 determines that the user is present in the room of the house (YES in S2), the control unit 66 of the control device 6 transmits the control information to the control unit 26 of the robot 2 such that the robot 2 operates at a speed equal to or lower than the maximum operation speed set by the user.

The control unit 26 of the robot 2 controls the moving portion 21, the telescopic portion 22, and the arm 24 so as to take out the desired package 12 from the accommodating portion 11, mount the package 12 on the mounting portion 23, transport the package 12 at a speed equal to or lower than the maximum operation speed set by the user (S3). With this process, the robot 2 can be caused to execute the task with the operation sound with which the user who is present in the room of the house does not feel uncomfortable, whereby discomfort of the user can be suppressed.

After that, when the robot 2 transports the package 12 to a desired location, the control unit 26 of the robot 2 transmits, to the control device 6, information indicating that the task is completed. When the control device 6 receives the information indicating that the task is completed, the control device 6 ends the task using the robot 2.

On the other hand, when the determination unit 64 determines that the user is not present in the room of the house (NO in S2), the control unit 66 of the control device 6 transmits the control information to the control unit 26 of the robot 2 such that the robot 2 operates at the normal operation speed.

The control unit 26 of the robot 2 controls the moving portion 21, the telescopic portion 22, and the arm 24 so as to take out the desired package 12 from the accommodating portion 11, mount the package 12 on the mounting portion 23, and transport the package 12 at the normal operation speed (S4). With this configuration, the robot 2 can be operated quickly.

After that, when the robot 2 transports the package 12 to a desired location, the control unit 26 of the robot 2 transmits, to the control device 6, information indicating that the task is completed. When the control device 6 receives the information indicating that the task is completed, the control device 6 ends the task using the robot 2.

As described above, the control device 6, the task system 1, and the control method according to the present embodiment operate the robot 2 at a speed equal to or lower than the set maximum operation speed when the user is present in the room of the house. Therefore, the robot 2 can be caused to execute the task with the operation sound with which the user who is present in the room of the house does not feel uncomfortable, whereby discomfort of the user can be suppressed.

On the other hand, the control device 6, the task system 1, and the control method according to the present embodiment operate the robot 2 at the normal operation speed when the user is not present in the room of the house. Therefore, the operation efficiency of the task by the robot 2 can be improved.

As a result, the control device 6, the task system 1, and the control method according to the present embodiment can achieve both the operation efficiency of the task by the robot 2 and the noise reduction.

Moreover, the user can set the maximum operation speed of the robot 2 to a speed at which the robot 2 operates at a speed equal to or lower than the noise level that the user does not feel uncomfortable with the operation sound of the robot 2 when the robot 2 operates while the user is present in the room of the house. With this configuration, the user can set the maximum operation speed of the robot 2 individually in accordance with the noise level that the user feels uncomfortable.

### Second Embodiment

In the first embodiment, when the user is present in the room of the house, the robot 2 is operated at a speed equal to or lower than the set maximum operation speed. However, the robot 2 in the room of the house may also be detected based on the detection result of the user detection unit 3, and when the robot 2 is present in a range preset by the user for the robot 2, the robot 2 may be operated at a speed equal to or lower than the set maximum operation speed.

### Other Embodiments

The control device and task system according to the above embodiment may have the following hardware configuration. FIG. 9 is a diagram showing an example of the hardware configuration included in the control device and the task system. As the procedure of processing in the control device and the task system has been described in various embodiments described above, the present disclosure may also take the form of a control method.

The control device shown in FIG. 9 includes a processor 101 and a memory 102 together with an interface 103. A part of the task system 1 and the configuration of the control device 6 described in the above-described embodiment are realized in a manner such that the processor 101 reads and executes a control program stored in the memory 102. That is, the control program is a program for causing the processor 101 to function as a part of the task system 1 or as the configuration of the control device 6. It can be said that the control program is a program for causing the task system 1 and the control device 6 to execute the process in the configuration or a part thereof.

The program described above is stored using various types of non-transitory computer-readable media and can be supplied to a computer (a computer including an information notification device). The non-transitory computer-readable media include various types of tangible storage media. Examples of non-transitory computer-readable media include magnetic recording media (e.g., flexible disks, magnetic tapes, hard disk drives), magneto-optical recording media (e.g., magneto-optical disks). Further, the examples above include a compact disc read-only memory (CD-ROM), a compact disc recordable (CD-R), and a compact disc rewritable (CD-R/W). Further, the examples above include semiconductor memories (e.g., mask ROM, programmable ROM (PROM), erasable programmable ROM (EPROM), flash ROM, random access memory (RAM)). The program may also be supplied to the computer by various types of transitory computer-readable media. Examples of transitory computer-readable media include electrical and optical signals and electromagnetic waves. The transitory temporary computer-readable medium can supply the program to the computer via a wired communication path such as an electric wire and an optical fiber, or a wireless communication path.

The present disclosure is not limited to the above embodiment, and can be appropriately modified without departing from the spirit.

In the above embodiment, the robot is caused to execute the task to transport the package 12. However, the type of task is not limited and may be a task such as housework support. Further, the configuration of the robot 2 is not limited to the above, and the robot 2 may have any configuration as long as the robot can execute a desired task. For example, the robot may also be a humanoid robot.

For example, although the robot 2 executes the task in the house in the above embodiments, the same can be executed in a facility such as a hotel where people stay.

What is claimed is:

1. A control device that controls a robot that operates in a facility used by a user, the control device comprising:
a detection information acquisition unit that acquires detection information of the user who is present in a preset area of the facility; and
a control unit that controls the robot such that the robot operates at a speed equal to or lower than a set maximum operation speed based on the detection information of the user.

2. The control device according to claim 1, further comprising a maximum speed acquisition unit that acquires the maximum operation speed set by the user, wherein the maximum operation speed is an operation speed of the robot at which a volume of an operation sound of a drive mechanism of the robot when the robot operates becomes equal to or lower than a noise level determined by the user.

3. The control device according to claim 1, wherein when the user is present in the area, the control unit controls the robot such that the robot operates at the speed equal to or lower than the set maximum operation speed.

4. The control device according to claim 1, wherein when the user is present within a range set for the robot, the control unit controls the robot such that the robot operates at the speed equal to or lower than the set maximum operation speed.

5. The control device according to claim 1, wherein the preset area of the facility is a room of a house used by the user.

6. A task system, comprising:
the control device according to claim 1;
a robot controlled by the control device to execute a task; and
a detection unit that detects a user who is present in a preset area of a facility.

7. The task system according to claim 6, further comprising a maximum speed setting unit used by the user to set a maximum operation speed of the robot.

8. A control method that controls a robot that operates in a facility used by a user, the control method comprising:
a step of acquiring detection information of the user who is present in a preset area of the facility; and
a step of controlling the robot such that the robot operates at a speed equal to or lower than a set maximum operation speed based on the detection information of the user.

9. The control method according to claim 8, further comprising a step of acquiring the maximum operation speed set by the user, wherein the maximum operation speed is an operation speed of the robot at which a volume of an operation sound of a drive mechanism of the robot when the robot operates becomes equal to or lower than a noise level determined by the user.

10. A control program that controls a robot that operates in a facility used by a user and that causes a computer to execute:
a process of acquiring detection information of the user who is present in a preset area of the facility; and
a process of controlling the robot such that the robot operates at a speed equal to or lower than a set maximum operation speed based on the detection information of the user.
